(19) United States
(12) Patent Application Publication
(10) Pub. No.: US 2017/0169195 A1
(43) Pub. Date: Jun. 15, 2017

(54) TECHNIQUES FOR GRANULAR LICENSING

(71) Applicant: salesforce.com, inc., San Francisco, CA (US)

(72) Inventors: Armand Glen LiSanti, Redmond, WA (US); Belinda Wong, San Bruno, CA (US); Durgaprasad Guduguntla, Santa Clara, CA (US); James Morris, Lynnwood, WA (US); Jun Huang, Seattle, WA (US); Matthew Small, San Francisco, CA (US); Saianitha Badrinath, Fremont, CA (US); Samarpan Jain, Fremont, CA (US); Si Wan Kim, Millbrae, CA (US); Vijaya Natanni, San Ramon, CA (US)

(21) Appl. No.: 14/970,388

(22) Filed: Dec. 15, 2015

(51) Int. Cl. G06F 21/10; H04L 29/08

(52) U.S. Cl. CPC G06F 21/105; H04L 67/06

(57) ABSTRACT

Techniques and architectures for granular licensing in a computing environment having access to an app exchange that provides a listing of multiple apps available to a remote client electronic device in response to a download request. A registration request corresponding to a software package having multiple modules is received. A license definition is transmitted from the management entity. The license definition includes a license for one or more of the multiple modules. The software package and license definition are registered with the management entity, so that only authorized management entities can store license definitions or grant licenses. The license definitions are stored in a memory associated with the management entity. One or more licenses are transmitted to a client electronic device. The one or more licenses correspond to one or more of the multiple modules of the software package that the client electronic device is authorized to utilize. The client electronic device is capable of acquiring the software package from the app exchange. The one or more licenses are capable of authorizing the client electronic device to utilize the one or more licensed modules.

### TECHNICAL FIELD

Embodiments relate to techniques for software licensing. More particularly, embodiments relate to techniques for providing increased granularity for licensing of applications and/or modules.

### BACKGROUND

An app is a (typically) self-contained program or piece of software designed to fulfill a particular purpose. For example, an app can provide business analytics functionality, weather information, stock information, sales related information, etc. An app is generally downloaded by a user to a mobile (e.g., smartphone, tablet) device, but apps can be provided to non-mobile (e.g., desktop, kiosk) device or a web application provided by a web browser. The traditional mechanism for distributing apps is to provide a “store” or other exchange that allows a user to access a collection of apps. This is typically arranged where a user has an account and can purchase the apps through the account. These stores are typically designed to have the greatest possible audience in order to provide greater sales. Licensing is usually accomplished in an all-or-nothing manner. That is, features are grantable by package licenses and applied the same way to each user who is granted access to the package.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a conceptual diagram of on-demand services environments that can provide access to an application exchange that can support and utilize granular licensing mechanisms.

FIG. 2 is a conceptual illustration of a technique and architecture for supporting granular licensing.

FIG. 3 illustrates a block diagram of an environment where an on-demand database service might be used.

FIG. 4 illustrates a more detailed block diagram of an environment where an on-demand database service might be used.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

As discussed above, currently software providers can only grant (or choose not to grant) access to a software package and cannot grant access to features within the package using traditional licensing techniques. Further, a software provider cannot provide certain features of a package at one cost and other features of the package at a different cost, or that some features should be licensed separately.

As described herein, a software package refers to software that has been compiled or interpreted from source code and includes additional meta-information including package description(s), package version information and/or dependencies. A software package is generally built with a package management system (PMS) that provides tools for installing, upgrading, configuring and/or removing software packages. The software package is typically presented as a single URL that refers to all of the information necessary to install the software/app including files and metadata that are only used during the installation process.

Described herein are various embodiments and techniques for supporting granular licensing mechanisms. Granular licensing allows software (or app) developers/providers (e.g., independent software vendors, ISVs) to distribute products at a per-user level for different sets of features contained within their app. For example, a customer can purchase 50 licenses for FeatureA and assign them to individual users (e.g., within an organization or group), and buy 25 licenses for FeatureB and assign them independently of the licenses for FeatureA, without being limited by user license or user type or other assigned licenses.

In one embodiment, software providers can choose a default set of licenses to be provided with the software package. These default licenses can be installed as part of the package installation. In one embodiment, these licenses can be overwritten or persisted by the software provider. In one embodiment, this can be accomplished via an application programming interface (API) that can support integrated granular licensing and sales.

In one embodiment, granular licensing can provide per-feature licensing. In one embodiment, software providers can provide several different licenses with different quantities, or licenses can be provided individually. For example, software or an app can be provided with a standard license and an admin license where the customer receives ten standard licenses and one admin license, but can purchase more of either type individually. In one embodiment, licensing can be based on user roles. For example, different subsets of features can be licensed to users with different roles.

In one embodiment, the granting of licenses is separate from enabling the software or app, which can provide an extra degree of flexibility. For example, licenses can be granted prior to rollout, and enablement can follow the license. On one embodiment, permission sets and/or profiles associated with users are utilized to control enablement and can be utilized to manage licenses.

In one embodiment, each software/app provider participating in an app exchange (or store) can configure and sell their own licenses and features/modules independent of each other and independent of configurations/choices of other software providers.

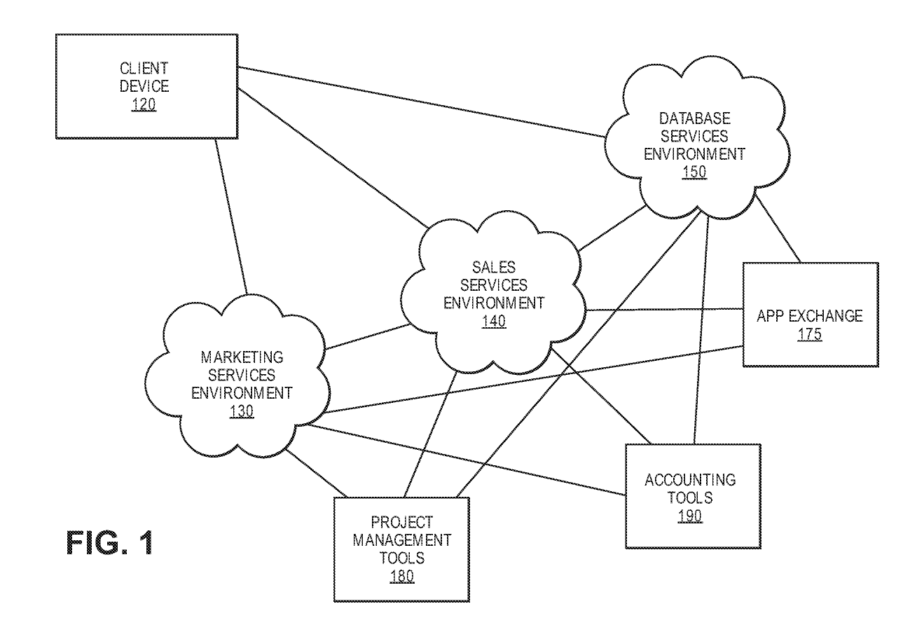

FIG. 1 is a conceptual diagram of on-demand services environments that can provide access to an application exchange that can support and utilize granular licensing mechanisms. The example of FIG. 1 is merely one of many configurations and environments in which an app exchange can be provided.

In one embodiment, a user may utilize client device 120 to access one or more of marketing services environment 130, sales services environment 140 and/or database services environment 150. In one embodiment each of marketing services environment 130, sales services environment 140 and/or database services environment 150 can be a multitenant on-demand services environment in which multiple tenants/organizations can have access to the environment while the data belonging to each tenant/organization is kept separate.

A tenant includes a group of users who share a common access with specific privileges to a software instance. A multi-tenant architecture provides a tenant with a dedicated share of the software instance typically including one or more of tenant specific data, user management, tenant-specific functionality, configuration, customizations, non-functional properties, associated applications, etc. Multi-tenancy contrasts with multi-instance architectures, where separate software instances operate on behalf of different tenants.

Marketing services environment 130 can, for example, provide marketing services such as email campaigns, social media marketing and analysis, online campaign services, mobile campaign services as well as data and/or analytics and/or marketing automation. Sales services environment 140 can, for example, provide customer relationship management (CRM) services of various types. Database services environment 150 can, for example, be a multitenant database environment.

In one embodiment, an on-demand services environment utilizes tenant/organization identifiers (IDs) within the on-demand services environment to allow individual tenants/organizations to access their data while preserving the integrity of other tenant's/organization's data. In one embodiment, a multitenant database environment, for example, stores data for multiple client entities each identified by a tenant/organization ID having one of one or more users associated with the tenant/organization ID. Users of each of multiple client entities can only access data identified by a tenant/organization ID associated with their respective client entity. In one embodiment, the multitenant database is a hosted database provided by an entity separate from the client entities, and provides on-demand and/or real-time database service to the client entities.

Client device 120 can be any type of electronic device that can access resources over a network. For example, client device 120 can be a laptop computer system, a desktop computer system, a smartphone, a tablet, a wearable computing device, etc. Client device 120 can interact with other electronic devices over wired and/or wireless networks. Services provided by marketing services environment 130, sales services environment 140 and/or database services environment 150 can be supplemented by additional nodes/devices/services, for example project management tools 180 and/or accounting tools 190.

In one embodiment, client device 120 can access an app exchange via one or more of marketing services environment 130, sales services environment 140 and/or database services environment 150. In one embodiment, a user of client device 120 can utilize a single identity to access one or more of marketing services environment 130, sales services environment 140 and/or database services environment 150.

In one embodiment, app exchange 175 may be provided via any of the services environments to distribute any app, whether custom to the organization or not, via a central, app exchange. In one embodiment, the user experience in app exchange 175 can be personalized by a user's role within the organization, a user's department, a user's business unit, a user's preferred language and/or other relevant factors. The apps made available at the app exchange can be publicly available apps and/or custom developed apps.

In one embodiment, app exchange 175 can be configured to distribute web-based, mobile and/or desktop apps that can be deployed to mobile devices, tablets, desktop, laptop devices with a single user entity. In one embodiment, each organization can customize the app exchange experience for users belonging to the organization.

In one embodiment, the app exchange is accessed via a browser window, which provides a user access to the features of the app exchange. In one embodiment, the app exchange provides a search function that allows a user to search for apps by, for example, name, functionality, type and/or other characteristics. Various filtering criteria may be applied.

Various app categories can be provided that can allow a user to narrow selections by category. In one embodiment, within a main screen area, various apps may be presented to the user. The user may be allowed to select one or more apps to utilize. In one embodiment, a user requests authorization before downloading the app. In other embodiments, the user may download the app and then request authorization, or the user may be allowed to download a trial version of the app, or the user may be allowed to use a limited version of the app.

In one embodiment, a software provider (e.g., ISV) can develop a software package in a development organization of a multitenant (or multi-organizational) environment. In one embodiment, after development, the software package is associated with a management organization that is responsible for provisioning the package. In one embodiment, the functionality and access to the package (or components of the package) are granted using custom permissions that are specific to the package and managed by the management organization. In one embodiment, the software package is distributed via an app exchange as described above.

In one embodiment, the management organization associates the software packages with license definitions or other objects associated with the package that can be used for granular licensing. In one embodiment, when a request is made for package installation, the app exchange initiates creation of an order on the management organization that targets the customer and provides the product associated with the package. In one embodiment, when the order is activated, provisioning triggers the package installation process and installation of the required permissions and/or licenses to the customer organization.

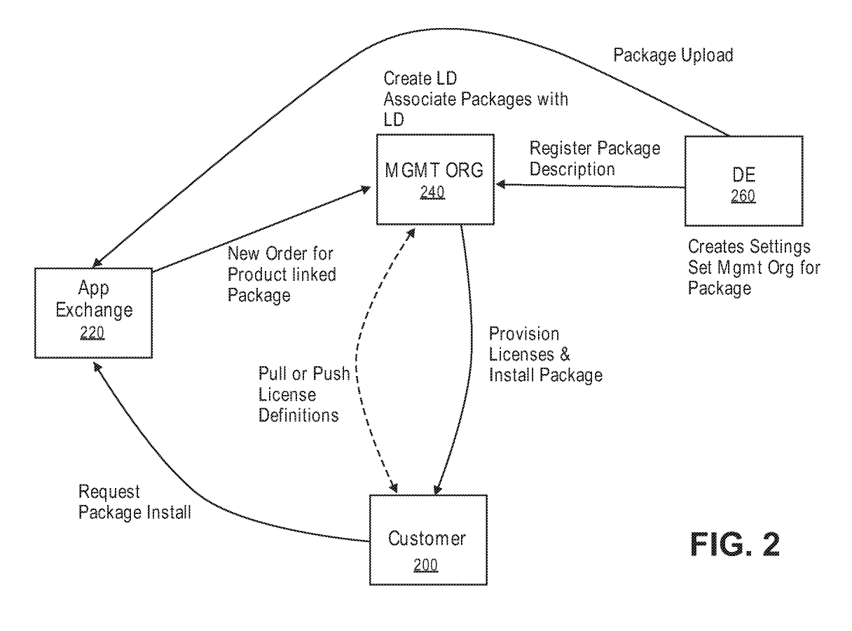

FIG. 2 is a conceptual illustration of a technique and architecture for supporting granular licensing. Various components of FIG. 2 can be implemented by one or more hardware computing devices. For example, one or more of the components of FIG. 2 can be provided within a multitenant environment or other computing platform.

In one embodiment, a software developer can utilize development environment (DE) 260 to develop and/or test a software application package. Development environment 260 can represent a broad range of development environments. The software package can be uploaded to app exchange 220, which operates as described above. The software package is also registered with management organization (MGMT org) 240.

In one embodiment, management organization 240 operates to manage a license definition (LD) to be associated with the software package (these license definitions can be created elsewhere, in the development environment or elsewhere, and registered with the management organization). In one embodiment, the license definition(s) include one or more custom permissions that can be utilized to authorize components of the software package.

In operation, customer 200 can access app exchange 220, for example, via a browser or other interface to acquire an app. In one embodiment, this includes requesting a package installation. In one embodiment, the app can be downloaded from app exchange 220 at that time, and then licenses/permissions can be acquired from management org 240. In another embodiment, the app can be downloaded after licenses/permissions are acquired from management org 240. In the example of FIG. 2, customer 200 represents an electronic device (e.g., smartphone, tablet, laptop, desktop, kiosk, wearable computing device) that a customer utilizes to acquire the app.

In one embodiment, in response to the request from customer 200, app exchange 220 initiates an order for the package with management org 240. In response to the order, management org 240 provisions the appropriate license(s) and causes/allows customer 200 to install the package or use additional features within the package as allowed by the license. In one embodiment, one or more license definitions may be pushed from management org 240 to customer 200. In another embodiment, customer 200 may pull license definitions from management 240. In yet another embodiment, a combination of pushing license definitions and pulling license definitions can be supported.

In one embodiment, management org 240 operates to manage licenses granted to any number of customers. In one embodiment, management org 240 operates to update licenses to customer 200 to provide additional licenses for one or more modules of the previously installed package in response to a request or purchase by customer 200. Similarly, licenses for one or more modules can be revoked or modified in response to events (e.g., expiration) that occur after the package has been installed.

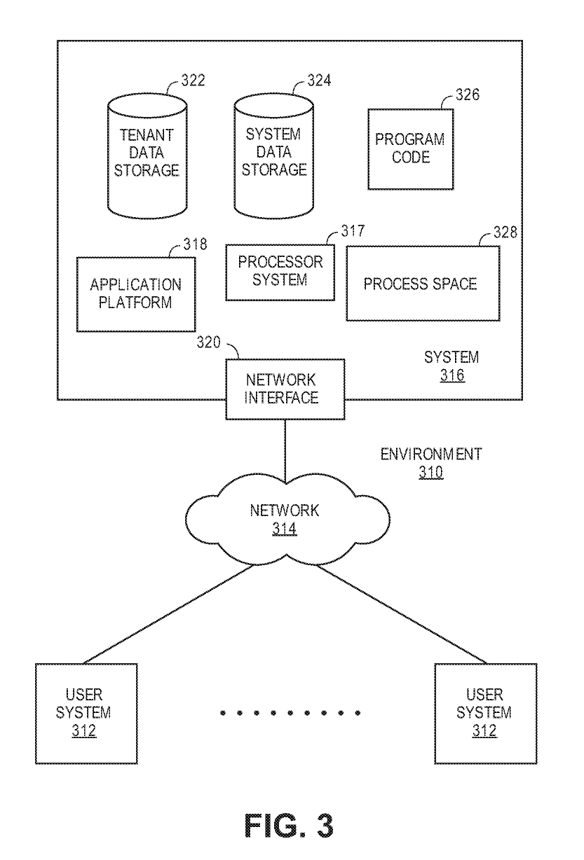

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

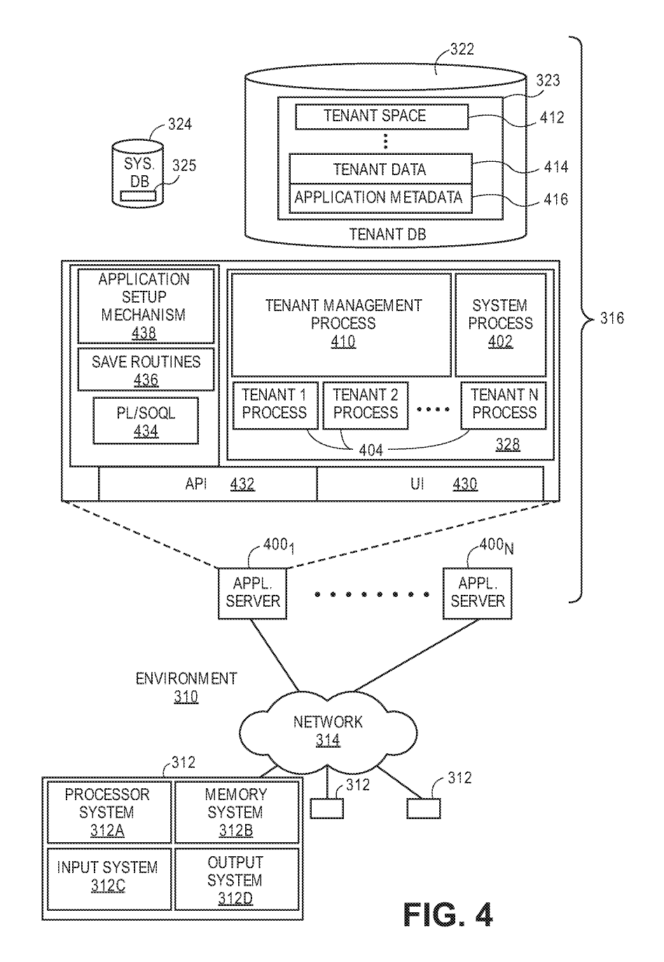

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in herein FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Pentium® processor or the like. Similarly, system 316 (and additional instances of an MTS, where more than one is present) and all of their components might be operator configurable using application(s) including computer code to run using a central processing unit such as processor system 317, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage space 412, tenant data 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage spaces 412, which can be either a physical arrangement and/or a logical arrangement of data. Within each tenant storage space 412, tenant data 414 and application metadata 416 might be similarly allocated for each user. For example, a copy of a user's most recently used (MRU) items might be stored to tenant data 414. Similarly, a copy of MRU items for an entire organization that is a tenant might be stored to tenant storage space 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 Big-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method for granular licensing in a computing environment having access to an app exchange that provides a listing of multiple apps available to a remote client electronic device in response to a download request, the method comprising:
receiving, with a management entity provided by at least one hardware computing platform, a registration request corresponding to a software package having multiple modules;
transmitting a license definition from the management entity, wherein the license definition includes a license for one or more of the multiple modules;
registering the software package and license definition with the management entity, so that only authorized management entities can store license definitions or grant licenses;
storing the license definition in a memory associated with the management entity;
transmitting, from the management entity, one or more licenses to a client electronic device, wherein the one or more licenses correspond to one or more of the multiple modules of the software package that the client electronic device is authorized to utilize, wherein the client electronic device is capable of acquiring the software package from the app exchange, the one or more licenses capable of authorizing the client electronic device to utilize the one or more licensed modules.

2. The method of claim 1 wherein the management entity pushes the license definitions to the client electronic device.

3. The method of claim 1 wherein the management entity provides the license definitions to the client electronic device in response to a pull operation initiated by the client electronic device.

4. The method of claim 1 wherein the management entity is configured to receive license settings from a development entity to be used to configure the license definition.

5. The method of claim 1 wherein the management entity receives, from the app exchange, an indication that the client electronic device has acquired the software package.

6. A method for granular licensing in a computing environment having access to an app exchange that provides a listing of multiple apps available to a remote client electronic device in response to a download request, the method comprising:
downloading a software package having multiple modules from the app exchange in response to a download request;
receiving, from a management entity, one or more licenses to the client electronic device, wherein the one or more licenses correspond to one or more of the multiple modules of the software package that the client electronic device is authorized to utilize;
assigning, the licenses received from the management entity, to one or more users within the client electronic device so that those users are granted access to the corresponding modules;
utilizing, with the client electronic device, at least one of the one or more licensed modules using the one or more licenses as authorization.

7. The method of claim 6 wherein the management entity pushes the license definitions to the client electronic device.

8. The method of claim 6 wherein the management entity provides the license definitions to the client electronic device in response to a pull operation initiated by the client electronic device.

9. The method of claim 6 wherein the management entity is configured to receive license settings from a development entity to be used to configure the license definition.

10. The method of claim 6 wherein the management entity receives, from the app exchange, an indication that the client electronic device has acquired the software package.

11. A non-transitory computer-readable medium having stored thereon instructions configurable to provide granular licensing in a computing environment having access to an app exchange that provides a listing of multiple apps available to a remote client electronic device in response to a download request, the instructions, when executed by one or more processors, to cause the one or more processors to:
receive, with a management entity provided by at least one hardware computing platform, a registration request corresponding to a software package having multiple modules;
transmit a license definition from the management entity, wherein the license definition includes a license for one or more of the multiple modules;
register the software package and license definition with the management entity, so that only authorized management entities can store license definitions or grant licenses;
store the license definition in a memory associated with the management entity;
transmit, from the management entity, one or more licenses to a client electronic device, wherein the one or more licenses correspond to one or more of the multiple modules of the software package that the client electronic device is authorized to utilize, wherein the client electronic device is capable of acquiring the software package from the app exchange, the one or more licenses capable of authorizing the client electronic device to utilize the one or more licensed modules.

12. The non-transitory computer-readable medium of claim 11 wherein the management entity pushes the license definitions to the client electronic device.

13. The non-transitory computer-readable medium of claim 11 wherein the management entity provides the license definitions to the client electronic device in response to a pull operation initiated by the client electronic device.

14. The non-transitory computer-readable medium of claim 11 wherein the management entity is configured to receive license settings from a development entity to be used to configure the license definition.

15. The non-transitory computer-readable medium of claim 11 wherein the management entity receives, from the app exchange, an indication that the client electronic device has acquired the software package.

16. A non-transitory computer-readable medium having stored thereon instructions configurable to provide granular licensing in a computing environment having access to an app exchange that provides a listing of multiple apps available to a remote client electronic device in response to a download request, the instructions, when executed by one or more processors, to cause the one or more processors to:
download a software package having multiple modules from the app exchange in response to a download request;
receive, from a management entity, one or more licenses to the client electronic device, wherein the one or more licenses correspond to one or more of the multiple modules of the software package that the client electronic device is authorized to utilize;
assign, the licenses received from the management entity, to one or more users within the client electronic device so that those users are granted access to the corresponding modules;
utilize, with the client electronic device, at least one of the one or more licensed modules using the one or more licenses as authorization.

17. The non-transitory computer-readable medium of claim 16 wherein the management entity pushes the license definitions to the client electronic device.

18. The non-transitory computer-readable medium of claim 16 wherein the management entity provides the license definitions to the client electronic device in response to a pull operation initiated by the client electronic device.

19. The non-transitory computer-readable medium of claim 16 wherein the management entity is configured to receive license settings from a development entity to be used to configure the license definition.

20. The non-transitory computer-readable medium of claim 16 wherein the management entity receives, from the app exchange, an indication that the client electronic device has acquired the software package.
